(19) United States
(12) Patent Application Publication
(10) Pub. No.: US 2006/0195442 A1
(43) Pub. Date: Aug. 31, 2006

(54) Network promotional system and method

(76) Inventors: Julian Malcolm Cone, Christchurch (NZ); Gary Lee Franklin, Christchurch (NZ); Grant James Ryan, Christchurch (NZ); William Ferguson Stalker, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/347,181

(22) Filed: Feb. 3, 2006

(30) Foreign Application Priority Data
Feb. 3, 2005 (NZ) 538061

(51) Int. Cl. G06F 17/30

(52) U.S. Cl. 707/5

(57) ABSTRACT

A search engine (1) capable of providing a listing of destinations (4) in response to searches for a user-inputted search term (6), said search engine (1) further providing at least one suggestions (10) listing derived from users previously inputted search terms (6) and/or destinations (4) selected, characterized in that at least one seeded suggestion (15) is incorporated in at least one suggestion (10) listing.

### TECHNICAL FIELD

The present invention relates to a means of targeting specific groups of users or networked users with relevant information, products or services.

### BACKGROUND ART

The prolific expansion and utilization of the internet has made internet search engines an indispensable feature of many users' internet usage. Numerous techniques are known for search engines to enquire, catalogue and prioritize websites according to predetermined categories and/or according to the particular search query. Numerous methods of enhancing the quality of the search results provided by search engines according to particular search queries are known, including those disclosed in the applicant's earlier patents U.S. Pat. No. 6,421,675, U.S. Ser. No. 10/155,914, U.S. Ser. No. 10/213,017 NZ518624 PCT/NZ02/00199, NZ528385, PCT/04/000228, NZ534459 and PCT/NZ2005/000192, incorporated herein by reference.

Conventional search engines filter and prioritize the search results providing a ranked listing based on: a) Keyword frequency and meta tags; b) Professional editors manually evaluating sites/directories; c) How much advertisers are prepared to pay, and d) Measuring which web-sites webmasters think are important implemented by link analysis, which gives more weighting to sites dependant on what other sites are linked to them, or a combination or permutation of any of the above.

U.S. Pat. Nos. 6,421,675, U.S. Ser. No. 10/155,914, and U.S. Ser. No. 10/213,017 disclose a means of refining searches according to the behavior of previous users performing the same search. These patents harness the discriminatory powers of the user to effectively provide a further filtering and screening of search results to the subsequent behavior when presented with search results listings. If a particular website is deemed to be of greater relevance, the user will typically access the website for some duration and/or perform other activities denoting a relevant website such as clicking on embedded links therein, downloading attachments, and the like. By preferentially weighting websites according to the user's behavior in relationship to a particular search query, the search engine is able to enhance the relevance of the search result listings. While this removes the web-site from its sole dependency of the above criteria a)-d) for its ranking, it is still driven by the influence of the whole web populous, whose interests and tastes may differ greatly from a given individual user.

U.S. Pat. No. 6,421,675, and application Ser. No. 10/155,914 also provides a means of deducing potential links between different keywords to create a keyword ‘suggester’ feature. When users performing searches with different search terms select a common destination from the search results, it can be inferred there is a connection between the two search terms. During subsequent searches for one of the search terms, the alternate derived search term may thus be suggested to the user as being possibly relevant.

PCT/NZ02/00199 discloses a personal contact network system whereby a user may form a network of contacts known either directly or indirectly to the user. The network may be used for a variety of applications and takes advantage of the innate human trait to give a higher weighting to the opinions of those entities with whom a common positive bond is shared, such as friendship. NZ pat app No. 528385 and PCT/04/000228 developed this technique by providing a means of influencing the ranking or weighting of search results according to the preferences of entities (individuals, groups or organizations) deemed of more relevance or importance to the user.

Clearly, a primary goal of search engines is to provide the most relevant results or ‘destinations’ in an appropriately ranked listing. Users will quickly move to a different engine if they are continually provided with irrelevant destinations, or if the most relevant destinations do not appear near the top of the results. However, as the search engines are predominately operated as commercial ventures, there is also a pressure to provide paid listings with the destinations as a revenue source. These paid listings are typically mixed with the conventional derived destinations and/or displayed specifically as sponsored links.

Some attempts to target the user with relevant sponsored links are known, usually derived from a correlation of the specific search terms, or the user's domain name (often to obtain geographic context) or from cookies. Nevertheless, such customization is often coarse and the sponsored links may be ignored by users. Moreover, these techniques are not passive in that some form of input from the user is required before a particular sponsored link is shown. It thus hinders the propagation of new issues or little known products that a company may wish to promote.

Search engines such as that discussed above also provide various techniques to optimize the relevance of search result destinations and improve interaction between individuals and groups with common interests. Such search engines or websites with search capabilities or the like may be provided listings of ‘suggested’ destinations and/or search terms. These suggestions listings may include popular or recent search terms and/or destinations. Variants of such listings may alternatively display suggestions ranked according to their rate of change according to a particular criteria rather than their absolute ranking, e.g. a listing of the destinations most rapidly increasing in popularity over a given time period. Thus, users may be tempted to access a particular destination, or perform a search for a suggested search term listed in the suggestions listing which may not otherwise have occurred. Nevertheless, the suggestions are still essentially passive in that they can only reflect the existing or previous situation.

Consequently, there remains a need for a means of providing relevant suggestions to users that may be used to stimulate and preferably propagate interest in specified search terms or destinations without initial instigation by the users.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

The present invention addresses the above difficulties by providing a means to:
market chosen search terms and destinations as seeded suggestions in the suggestions feature (or ‘what’s hot) feature of typical search engines
optionally, though preferably, to target the seeded suggestions to relevant groups of users.

By showing users lists of suggestions that are of interest to a user's network of contacts (both social and/or organized groups/networks) and including potentially relevant seeded suggestions, the marketed terms will propagate only in networks where they are deemed relevant. This mimics ‘word of mouth’ marketing whereby users may verbally recommend items of interest or relevance to other parties they know find them useful.

Previously, to market several disparate items to a large number of potential users required either marketing each term to all the users, or undertaking potentially costly market research to segment the users into relevant sections for each marketed item. In contrast, the present invention allows relevant seeded suggestions displayed to even a small numbers of users to propagate to further, but only to relevant users.

The present invention may preferentially draw on the capabilities described in the inventor's earlier applications for weighting search results, personal contact networks and adaptive search engine filtering as described more fully below.

Thus, according to one aspect of the present invention there is provided a search engine capable of providing a listing of destinations in response to searches for a user-inputted search term, said search engine further providing at least one suggestions listing derived from users previously inputted search terms and/or destinations selected, characterized in that at least one seeded suggestion is incorporated in at least one suggestion listing.

The suggestions and associated seeded suggestions may be displayed to the user by a variety of methods, both ‘integrally’ and ‘externally’ to the search engine. As used herein, the terms ‘integrally’ relates to suggestions displayed together with a dynamic link to the search engine, i.e. a search engine web page, or a search toolbar or equivalent where the user can input search terms directly and where the suggestions may be dynamically updated.

The term ‘externally’ is used to denote any means whereby suggestions are displayed to the user without a corresponding dynamic link to the search engine, such as electronic newsletter, emails, text messaging, RSS feeds or even conventional postal services. A user, receiving an email or electronic newsletter for example, may click on any of the suggestions to hotlink to the relevant destination or to have a particular search term executed.

Preferably, said seeded suggestions occupy a defined proportion of the suggestions displayed to a user. Preferably, said defined proportion includes a proportion of the time, and/or the number of suggestions displayed to the user.

In one embodiment of the present invention, said seeded suggestions are displayed to users meeting predetermined user parameters. Preferably, the user parameters include, but are not restricted to, the user's search history, entity attribute, identifying characteristic, connection factor or any other convenient factor by which the type of user may be distinguished. As an example, a user whose search history shows an existing tendency to select suggestions is clearly more likely to be receptive to seeded suggestions than a user who never clicks on a suggestions link.

Although the present invention is applicable for search engines utilized on any suitable network including local and wide area networks (LAN and WAN respectively), intranets, mobile phone services, text messaging, and the like, it is particularly suited to the internet and the invention is described henceforth with respect to same. It will be appreciated this is exemplary only, and the invention is not limited to internet applications. Consequently, although the term destinations encompasses not only web sites and web pages but also any discrete searchable information item such as images, downloadable files, specific texts, music, video, or any other electronically classifiable and/or searchable data, reference is made henceforth to destinations as internet web pages.

The term ‘search engine’ is not necessarily restricted to Internet search engines and may also include any other electronic data search systems for interrogating databases and or networks. Although the present invention is described herein with respect to an Internet search engine, it should be understood this is for exemplary purposes only and the invention is not necessarily limited to internet application.

A search term is defined as any keywords, images, sounds, alphanumeric data, and/or any other query used as the user input for searches performed by the search engine.

Suggestions Listings

The term suggestions is defined herein as incorporating both destinations and search terms. Suggestions listings are commonly found on search engines to provide users with an insight to topical issues and websites of interest to other users. Simply by sighting such suggestions, users may be tempted to access websites or perform searches for search terms they would otherwise not have undertaken. This feature largely draws on natural human curiosity, a desire to investigate what and why other users find interesting.

Preferably, said suggestions include, but are not restricted to:
recent searches denoting the most recent search terms selected by users over a defined period;
recent destinations denoting the most recent destinations (e.g. websites) selected by users over a defined period;
popular destinations denoting a ranking of destinations most regularly visited by users over a defined period;
popular searches denoting a ranking of the most popular search terms selected by users over a defined period;
high-flying searches denoting a list of search terms ranked according to their rate of change in the popular searches ranking;
high-flying destinations denoting a list of destinations ranked according to their rate of change in the popular destinations ranking;
Recent, popular, high-flying searches or destinations for paid or sponsored web listings.

In contrast, a seeded suggestion is not a calculated suggestion obtained directly or entirely by one of the above methods or any other measurement of user-activity. Rather, a promoter may utilize the search engine to actively insert or ‘seed’ the conventional suggestions listings with their seeded suggestion. The term promoter includes any commercial or non-commercial entity, organization, network or individual who wishes to promote, market or simply generate interest in a particular destination or search term, i.e. the promoter's seeded suggestion. Thus, a promoter may also be the search engine proprietor/controller.

While a seeded suggestion may be targeted to relevant users according to their particular interests or the like, its origin is not based on the actual search terms or destinations figuring in the above recent, popular and high flying suggestions, but on what the promoter would like to market/promote. If successful, the seeded suggestion may receive sufficient user attention to appear in the suggestions listings via the conventional route.

As discussed above, the suggestions (including seeded suggestions) can be exposed to the user both integrally with, and externally to, the search engine. Externally displayed suggestions may be distributed to users via any convenient medium such as email; electronic newsletters; RSS feeds, text messaging and the like and provide a powerful mechanism to further target marketing to relevant users.

By distributing an electronic newsletter, for example, to users with an identified common interest, the suggestions displayed therein (together with the embedded seeded suggestions) can be accurately focused to the particular common interest. Personal contacts networks, search groups and any other user parameter (e.g. the user's search history, entity attribute, identifying characteristic, connection factor or the like) may be used to select the target audience for such externally displayed suggestions. The common user parameter may be membership of an organized network, or customer direct email or relationship database, whereby the membership provide a distribution list for an email, or newsletter containing promotional material, information and suggestions of searches and destinations relevant to the membership. Though not essential, an electronic distribution format enables any recipient to forward the material to their friend and contact who they believe will find it of relevance. This is a significant advance on traditional externally driven marketing campaigns because the recipients can themselves choose to propagate the material to a wider audience only if they feel it is of relevance. Irrelevant material would quickly be discarded and cease to propagate.

The externally distributed suggestions communication forwarded to other users may also include an invitation to join the respective organized network, search group, or personal contact network linking the recipients of the original distribution list. The newsletter recipients may be given the choice of either, using the suggestions temporarily and/or anonymously or signing-up and confirming their wish to join the focused search ‘community’ instigating the newsletter/communication. Subscribing members would thus be accessible to subsequent campaigns and newsletters. This potentially provides a highly receptive and focused target audience for the seeded suggestions. Optionally, the user may be provided with a link to install a search engine toolbar focused on the specific theme/interest of the newsletter providing automated newsletter updates, specific suggested searches, advertising, news, and/or inter-community communication (e.g. chat and messaging and the like) for the subscribing members.

The suggestions/seeded suggestions distributed ‘externally’ may either be accessed anonymously (i.e. the user clicking on the link cannot be identified) or they can be customized for each individual recipient or grouping of recipients. In the latter case, both the promoter of the seeded suggestion and (if different) the initiator of the campaign can obtain precise feedback on which recipients or group of recipients found the suggestions, seeded suggestions or any other links included in the communication to be of use. This provides a unique method of linking traditional integrated online marketing methods (CRM databases, email lists, customer profiles) with externally distributed marketing and advertising methods (email, direct mail, electronic newsletter, etc.) to obtain feedback on success and guidance for future campaigns.

Relevance of User Selections

Popularity of a destination or search term may be calculated directly from a cumulative ranking of those selected or inputted respectively by users over a defined measurement period. As discussed above, a conventional search engine typically provides a ranked search result listing based on a) keyword frequency and meta tags; b) manual evaluation of web site by professional editors; c) advertising fees, and d) link analysis or a combination of same. Improvements over these methods are afforded by the technology employed in the applicant's earlier patents U.S. Ser. No. 09/115,802, U.S. Ser. No. 10/155,914, U.S. Ser. No. 10/213, 017 NZ518624 and NZ528385 to applying weighting to the search results by increasing (and/or optionally decreasing) the ranking of a selected destination over an unselected destination in the search results listing.

The present invention preferentially (though not essentially) utilizes the above technologies. However, a selected destination may prove irrelevant to the user after viewing and thus should not receive a preferential ranking. To counteract such potential distortions of the results weighting, preferably said search engine classifies a selection of destinations as being relevant when the user performs at least one action in association with the selected destination to meet at least one predetermined relevancy criteria.

Similarly, according to one aspect, the search engine reduces the ranking of a selected destination when the user does not perform at least one action in association with the selected destination to meet at least one predetermined relevancy criteria, said selected destination being classified as irrelevant.

Thus, said predetermined relevancy criteria includes, but is not limited to, whether the user accesses a destination for longer than a predetermined period (a lengthy access period implying the item was of interest), accesses further destinations directly from the first selected destination and/or submits/downloads data to/from the destination. An irrelevant destination may be classified as the failure of the user to perform any of these actions. The relevancy criteria may be varied according to the specific characteristics of the search, e.g. search terms relating to sporting results, or fixture dates characterized by brief access times, in contrast to scientific or engineering search terms where users would spend longer on a relevant website.

To retain the suggestions listing's raison d'être, it is undesirable for them to be disproportionately populated with seeded suggestions. It is thus preferable to introduce seeded suggestions into the suggestions listings in a manner that does not distort the primary classification of the suggestions listing. Moreover, it is desirable to enable only relevant seeded suggestions to be propagated, preferably to targeted users. The suggestions listings typically provided by conventional search engines are ‘global’ lists, i.e. formed from the activities of all users of the search engine. Given the extremely large number of users accessing search engines, such global suggestions listings can only provide a crude indication of popular suggestions and cannot reflect the specific interests of different types of users. While the present invention may readily be used with such global suggestions listings, a more targeted approach would clearly be beneficial. The inventors' earlier referenced applications provide search engines with specialized or ‘focused’ suggestions listings derived from groups associated with, or of interest to the user. As detailed below, the present invention may make use of these capabilities to target the seeded suggestions to relevant users.

Personal Contact Networks/Organized Networks

As previously referenced, NZ Pat App No. 528385 and PCT/04/000228 developed the techniques disclosed in PCT/NZ02/00199 to providing a means of influencing the ranking or weighting of search results according to the preferences of entities (individuals, groups or organizations) deemed of more relevance or importance to the user. In addition to weighting the search results destinations, it also provides corresponding suggestions listings corresponding to the searching and web surfing activities of the user contacts in the user's personal contacts network. PCT/NZ02/00199 discloses a system providing one or more users with a unique, personal contacts network formed from contacts with one or more entities known directly or indirectly to the user, characterized in that said unique personal contacts network provides respective interrelationship context information associated between at least two entities and/or between an entity and the user. PCT/04/000228 provides a search engine system capable of displaying indicative information to a user from searches performed by one or more entities connected directly or indirectly with the user.

The present invention may incorporate both the above capabilities. Moreover, the present invention may interface with organized networks or groups (i.e. users having one or more common entity attribute(s)), either directly or via a user's personal contacts network.

Thus, according to one aspect of the present invention there is provided a search engine capable of providing a listing of destinations in response to searches for a user-inputted search term, said search engine further providing at least one suggestions listing derived from users' previously inputted search terms and/or destinations selected, characterized in that at least one seeded suggestion is incorporated in at least one suggestion listing, said search engine being further capable of interfacing with a personal contacts network (either private or open) formed from contacts with one or more entities known directly or indirectly to the user, wherein said unique personal contacts network provides respective interrelationship context information associated between at least two entities and/or between an entity and the user.

According to a further aspect, the present invention provides a search engine capable of providing a listing of destinations in response to searches for a user-inputted search term, said search engine further providing at least one suggestions listing derived from users' previously inputted search terms and/or destinations selected, characterized in that at least one seeded suggestion is incorporated in at least one suggestion listing, the search engine being further capable of displaying indicative information to a user from searches performed by one or more entities connected directly or indirectly with the user.

In one embodiment, said entities are ‘user contacts’.

As used herein, the term ‘entity’ or ‘entities’ refers to any individual, family, personal or organized network, organization, club, society, company, partnership, religion, or entity that exists as a particular and discrete unit.

Preferably, the present invention provides indicative information in the form of suggestions and (optionally) destinations weighting.

Preferably, each user contact includes a connection factor indicative of the degree of separation between the user contact and the user.

In one embodiment, the said connection factor incorporates a connection path length between two entities, given by the minimum number of connections in a chain of entities separating two entities.

In a further embodiment, the said connection factor incorporates the degree of separation between two entities and is equal to the shortest connection path length of all the available connection paths between the entities, wherein an entity that is directly connected to another entity is said to be a direct contact giving a “1^{st} degree contact,” and has a connection path length of one; two entities connected via one intermediate entity are said to be “2^{nd} degree contacts,” and have a connection path length of two, and wherein any two entities whose shortest connection path is via “N-1” intermediate entities (if any), with a path length of “N” are an “N^{th} degree contact, where “N” is an integer. Entities having a 2^{nd} or higher degree contact are said to be indirect contacts, or indirectly connected.

Preferably, said personal contacts networks provide interrelationship context information between said entities and/or between a user contact and the user, said interrelationship context information including said connection factor and optionally one or more entity attributes.

Preferably, said entity attributes include information regarding personal details, factors or interests; friends; relations; school alumni; employment factors; business colleagues; professional acquaintances; sexual preferences, persuasions, or proclivities; sporting interests; entertainment, artistic, creative or leisure interests; travel interests, commercial, religious, political, theological or ideological belief or opinions; academic, scientific, or engineering disciplines; humanitarian, social, security/military or economic fields, an identifying characteristic, membership of organized networks and any combination of same.

Preferably, in addition to a connection factor indicative of the separation between an entity and the user, said interrelationship context information optionally also includes a connection factor indicative of the separation between user contacts in said personal contacts network.

As discussed above, the indicative information may include search suggestions and/or search results weightings derived from searches, search results, or other network/internet-related activities of the user contacts.

This enables a powerful insight into the activities of the user contacts that may be of direct relevance for a variety of reasons. In the case of close friends (i.e. direct contacts) the suggestions are likely to be in areas of similar interest to the user, or of interest purely due to the existing relationship between the entities. Similarly, if the linking interrelationship context information between the entities and the user is a common entity attribute of membership of a common organization such as a large company for example, the suggestions from the other entities may be of relevance for commercial purposes.

Thus, for embodiments of the present invention wherein users receive input from user contacts in their personal contacts network, the associated recent, popular, high-flying searches and destinations suggestions previously listed may be compiled from the user's user contacts instead of all the users accessing the search engine.

Thus, it can be seen that the above embodiments enable the relevance of suggestions shown to a user to be enhanced by utilizing a personal contacts network. Consequently, a promoter may choose to target a seeded suggestion to certain user contacts within a personal contacts network which all have a common interest related to the seeded suggestion. As an example, if a promoter wishes to promote a new website for archery, they may choose to seed the popular, high-flying and/or recent destinations suggestions with the new archery website. Similarly, they may seed the popular, high-flying and/or recent searches suggestions listings with appropriate keywords relevant to their website.

The probability of the user contacts accessing one of the seeded suggestions would be increased if for example, the user contacts had an interest in target sports, hunting or medieval weaponry or knew a close acquaintance (i.e. a direct contact) with an interest in archery. Consequently, the interrelationship context information, including the connection factor, entity attributes and identifying characteristics may be used as criteria in determining which user contacts receive the seeded suggestion in the suggestions listings displayed to them.

Not only would appropriate targeting to user contacts with relevant interrelationship context information increase the likelihood of accessing the seeded suggestions, it also increases the propagation of the seeded suggestion. As an automatic consequence of user contacts accessing a particular destination, or inputting a particular search term, there is an automatic ripple effect to through the user contact's corresponding personal contacts network, both in the subsequent weighting applied to search results for the same search terms, and to the suggestions displayed. It also ensures the seeded suggestion is less likely to propagate through personal contacts networks of users uninterested in subject matter of the seeded suggestion.

Thus, personal contacts network may be utilized by the present invention in two separate ways; i) a user having a personal contacts network who also wishes to market/promote a particular suggestion themselves may seed it into the suggestions in their own network, or ii) a promoter may target particular users within any personal contacts network meeting said predetermined user parameters which may be chosen according to a user's search history, entity attribute, identifying characteristic, connection factor or the like relevant to the nature of the seeded suggestion.

According to a further aspect of the present invention, a user may vary the suggestions displayed from the user contacts of their personal contacts network based on a selective input from the user contacts. The selective input may filter the suggestions according to at least one filter criteria including the elapsed period since the suggestion creation, the interrelationship context information, the connection factor and/or entity attributes of the contributing user contact.

The suggestions may be displayed at any convenient location, e.g. adjacent the search results, as a static or scrolling list or as an optional toolbar or window with corresponding labeling or some generic terms such as “What's Hot” or the like.

In a preferred embodiment, the suggestions and seeded suggestions are displayed in a non-linear cluster arrangement, or grouping. Preferably, the size, location or visual prominence of the individual suggestions and/or seeded suggestions with respect to each other is variable by the search engine. Thus, the suggestions may be represented as a ‘cloud’ of suggestions, adjacent a search box. The relative prominence of the individual suggestions and/or seeded suggestions with respect to each other is configurable by varying the size, colour, contrast, shape, audio output and/or any other suitable visual, audio-visual or audio means distinguishable to a human user. Preferably, said seeded suggestion prominence is at least partially governed by the magnitude of a display fee other paid by a promoter, the display duration and previous popularity in preceding searches. Whilst such clusters or ‘cloud’-type displays of suggestions are known (also referred to as ‘tag-clouds’), they may be utilised in the present invention as a means of varying the impact of the seeded suggestions on the user and overcome the implied ranking associated with a displaying a linear list of suggestions.

It will be appreciated that there is a distinct difference in the present invention between organized networks and personal contacts networks. An organized network forms a group/organization with defined memberships who all have a common aim, or interest such as, commercial organizations, companies, corporations or groupings; political parties; academic or engineering institutes; sporting bodies and so forth. Thus, all organized network members have at least one common entity attribute, i.e. membership of the organized network.

In contrast, a personal contacts network is formed from contacts with friends and colleagues that are unique to an individual. Thus, an individual user of the present invention may be linked to other entities' personal contacts networks and be linked (or even be a member of) organized networks. The present invention provides the flexibility to regard organized networks such as a commercial company or an institute of engineers as a single user contact with various entity attributes relating to the whole company/organization, an/or to consider the individual members of the organized networks as individual user contacts with at least one common entity attribute.

According to one embodiment, the present invention is configured to allow a user to apply a selective input to the user's suggestions by using a filter criteria of controlling the value of N^{th} degrees contact of entities to be included, where N is a variable determined by the user.

In a further embodiment, the filter criteria for said selective input may be linked to a predetermined activity. Thus, if the user is interested in a particular event, or activity, they may tailor their user contacts to reflect particular aspects of the predetermined activity.

Alternatively, a user engaged in one or more said predetermined activities may specify the action to apply to
all degrees of contact in the user's personal contacts network, at any connection path length, or
the entire system network of all nodes, including those who are not connected to the user.

Preferably, said predetermined activities include (but are not limited to) consumer decisions, buying, selling, trading loaning; finding flatmates/roommates, tenants; organizing activities and events, recommendations/opinions including those related to films, plays, books, employment, services, tradesmen, accommodation, restaurants and the like, comparison and explorations of common interests, e.g. horse riding, snowboarding, etc; sharing peer-to-peer personal or business creative work or content, e.g. photos, art-work, literature, music; managing a club or society; locating/supplying/“blacklisting” providers of goods or services; business or technological advice unsuitable for publication; recruitment, job-seeking; estate agents; venture capital; collaborative ventures; referrals; police/security information gathering/informants; event manager; address book manager; headhunting; book mark service; spam filtering; car sharing; sales leads; market entry advice; real-estate; sharing personal or business files; company knowledge management; medical advice; travel organizer, lending/borrowing; house-sitting; baby-sitting; classified advertisements; finding musicians.

In addition, the present invention permits said selective input to be received from networks outside the system network.

It will be appreciated that there are numerous potential reasons for limiting the degrees of separation of entities used by the user for any selective input, said reasons including, but not limited to, social, economic, or political contexts such as trust, discretion, interest, association, preference, shared experience, ethnicity, religion, language, location, allegiance, alliance, treaty, politics, or governance. It will be appreciated there are numerous methods of customizing the selective input to the user's suggestions. In one embodiment, the suggestions are a weighted average of direct contacts and indirect contacts. In alternative embodiments, the selective input may be defined by the user.

The user contacts associated with the suggestions most frequently chosen by the user may be designated preferred user contacts. The designation of preferred user contact may be performed directly by the user, or calculated by the system by determining the user contact associated with the most popular suggestions previously selected by the user. In yet further embodiments, the selective input may be at least partially weighted to suggestions from the preferred user contacts.

Adaptive Filtering

The applicant's earlier patent applications NZ Pat App 534459 and PCT/NZ2005/000192 (incorporated herein by reference) discloses an adaptive search engine providing a further means of enhancing the relevance of search results by a weighting applied to search results derived from the effects of filters applied by the user and or the search engine.

Thus, in one embodiment the search engine records an association between a filter applied to a search term and an individual destination selected by a user from a filtered portion of the destinations listing, wherein each recorded association contributes to the weighting given by the search engine to application of said filter in a subsequent search for at least one keyword of said search term.

Preferably, said filters include, but are not limited to: one or more said data sources; Keyword filters; user submissions—including user comments, answers to questions, chat-room threads, blog inputs and the like, news, pictures; search groups; human editorial control/moderator; user-behavior analysis; Keyword suggestions; Website filter, Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or Mature Content filter.

The term data sources as used herein includes, but is not limited to, search groups, web sites, domain names and categories, personal contact networks, news groups, third party search engines including category-specific search engines, geographical regions, blog sites, intranets, LAN and WAN networks, and/or any other form of searchable source of data.

Search groups are a form of organized network providing a potentially powerful and flexible search feature, particularly in conjunction with the present invention. In its basic form, a search group is a category-specific group which shares its search results and preferred data sources; essentially they are groups of users with similar views of what is relevant, i.e. they have at least one common entity attribute.

Thus, while the members of the ‘Fishing’ search group for example would pool search results on all matters pertaining to fishing, the same members may also be members of other search groups and are thus not obliged to have a fishing bias on any non-fishing searches they want to perform. The searches within a search group may be configured as self regulating in that the users will naturally perform searches targeted towards the stated aim or ethos of the group and consequently will choose searches with appropriate or relevant search terms. The user selections from resulting destinations will be re-ranked according to the relevancy or irrelevancy of the result according to the techniques previously discussed. Thus when a user performs a search query for search terms already searched by other group members, the result listings generated will already display combined effects of all the previous re-ranking performed for the same search terms by the other search group members. It may optionally also display one or more lists of sites obtained from the direct or indirect recommendations of the group members, generating corresponding suggestions listings for the respective search group, said lists including the previously mentioned popular, high-flying and/or recent destinations suggestions listings. These lists need not be restricted solely to searches within a single search group, but may also be generated for a user performing a search outside a search group and /or drawing results from one or more data sources/search groups.

The present invention may utilize these capabilities to enhance the targeting of the seeded suggestions and to aid in their propagation though other users with similar tastes, interests or the like. Thus, by placing a seeded suggestion in the suggestions listings of a search group with a relevant theme, the promoter has an increased assurance that the search group membership will find it of interest and access it. The same benefits apply equally to members of a search group wishing to distribute their own seeded suggestions. Moreover, these benefits are also attractive from a search engine proprietors' perspective in that by displaying multiple seed suggestions to different users, the overall uptake is likely to be higher with a consequential increase in revenue.

Thus, according to further aspects, the present invention provides a search engine incorporating the capabilities of the adaptive search engine disclosed in PCT/NZ2005/000192, and a search engine capable of interfacing with such an adaptive search engine. Although PCT/NZ2005/000192 discloses numerous features (incorporated herein by reference), the following illustrates how the ability to infer the interests of the user from a) their response to the search filters applied to their searches and b) their choice of search group membership may also be used to effectively target the placement of seeded suggestions.

Search groups may also be formed indirectly from users using a search engine link on a category-specific or specialized web-site. Thus, even if users do not overtly join a particular search group, it can be inferred form the user's presence on the specialized web-site that the user has an interest in the subject matter of the website and that any searches they perform from that site would be at least generally related to the same subject matter. Thus, the nature of the web-site hosting the search link may be used as the source of one of more filters applied to searches undertaken through that site. Internet users typically lack the incentive or willingness to actively customise searches by actively applying filters or joining search groups. The use of subject specific websites with an associated search engine link thus enables relevant search filters to be passively derived providing a more appropriate focusing of both the search results (and therefore the suggestions) and the seeded suggestions.

Thus, in addition to the ability to interface with personal social networks, the present invention is also able to harness the search activities of groups of like-minded individuals simply by use of search facilities hosted on special-interest web sites and targeting the seeded suggestions accordingly.

The adaptive search engine is able to further improve the relevancy of the destinations listings (irrespective of how the destinations listings are initially obtained) by ‘learning’ from recording the effect on the user's behavior of any filters applied. Considering an example where the user inputs a search term with the keyword “job vacancies”, an unrestricted search would produce a plethora of search results. Thus, the search engine may for example apply the keyword filter “New Zealand” for users with a New Zealand IP address and mix the resultant destinations with the standard destinations in the listings provided to the user. By recording which destinations the user accesses (particularly ‘relevant’ destinations as discussed above) the relevance of the filter (i.e. the term “New Zealand’) can be determined by the proportion of users accessing the filtered portion of the results. The association between user-selections of destinations from the filtered portion causes the search engine to affect the weighting given to the application of the filter. This weighting may be adjusted in numerous ways, e.g. if the majority of users accessed results including the “New Zealand’ keyword, the search engine could increase the portion of the search results subjected to the filter. Equally, if it was found the filtered portion received no additional attention from the user, the filtered portion of the results may be decreased or even eliminated. Alternatively, alterations in the weighting given by the search engine to the filter may relate to altering the ranked position of the filtered results within the search listings.

The present invention may also apply the same principles to controlling the distribution of the seeded suggestions amongst the users of a search engine. As an example, the search engine may identify common factors between users selecting a seeded suggestion and target the corresponding suggestions listings applicable to other users with the same common interests or attributes. If several users selecting a seeded suggestion from a global suggestions list are also members of a particular search group, it may be effective to also place the seeded suggestion in the suggestions listing for that search group. Identifying and utilizing such common factors between users would be possible even if the users were not actively using their common search group at the time of the seeded suggestion selection. Also, the search engine may identify any other common factors between users selecting seeded suggestions aside from membership of a search group. These common factors (e.g. entity attributes, geographical indicators, connection factors, user's search history etc) may also be used to target other suggestions listings with the seeded suggestion.

Users associated with search groups provide the search engine with context information from which to select relevant filters. When such a user performs a general search query (i.e. without specifying any specific filter), the search engine checks the search term keywords against at least some of the search groups the user is associated with for any re-ranked results and if so, incorporates them in the general search results listing. If the user happens to be performing a search with no association to the topics of their search group memberships, the unbiased or unfiltered results are still listed for possible selection. Conversely, if the user's interest in destinations with an emphasis on the subjects of their search groups is an overriding factor, they will naturally tend towards selecting relevant results from the filtered portion of the search results listings and thus increasing the weighting of the search engine in applying the filter.

It can be thus seen that the search engine will learn over time which filters are effective and which have little beneficial impact and adapt accordingly. The initial or default choice of filters may be made manually by the user, or by a search group or search engine moderator and/or inferred from settings specified external to the search engine.

A user's search history can be compared with other users to identify similar search patterns. Close matches may be used to add (or suggest being added to the user) search groups common to the parties and/or even create a new search group for the matched users. As it may be inferred the matched users have similar tastes, it creates the possibility for social or business networking by allowing the users to communicate with each other (email, on-line messaging or the like) to discuss their mutual interests. This also provides another effective basis for determining which suggestions listing to place seeded suggestions.

If a user's pattern of search activity (queries and results) has similarities with those of particular search groups, the user may automatically be added or invited to join the search group. Similarly seeded suggestions may also be placed in suggestions listings of search groups of users whose search behavior corresponds to those of the search group members.

In a further embodiment of the adaptive search engine, the initial filters applied by the search engine are selected according to one or more context indicators. Thus, according to a further aspect, the present invention provides a search engine substantially as described above, wherein initial selection of said filter is either user-selected or calculated from one or more predetermined relationships incorporating at least one context indicator related to characteristics of the user, the filter or both.

As used herein, context indicators include any definable and recordable facet or characteristic of a filter selected by a user and/or a user's interests, contact details, personal or bibliographic details, previous search behavior, web surfing behavior, cookie information, occupation, membership or use of search groups, information shared as part of trusted personal contacts networks, geographical location, language, domain name type, data voluntarily inputted by the user into the search engine.

Thus, context indicators also provide a yet further means to target seeded suggestions to the most relevant users.

Integration of the present invention with adaptive search engine technology and the personal contacts network technology of Patent Application Nos. NZ 514368, NZ 518624 and PCT/NZ02/00199 permits context indicators optionally to be obtained directly from the data recorded on each individual. Knowledge that the user has an interest in ornithology for example can cause the search engine to introduce destinations with search terms associated with the most popular search terms used in the ornithology search group, or for the most popular related search term to ornithology.

The technology associated with the generation of related search terms is well established as discussed in U.S. Pat. No. 6,421,675 and Patent Applications U.S. Ser. No. 10/155,914, U.S. Ser. No. 10/213,017, CA2,324,137, JP2000/537158, KP2000-7010220, NZ507123, IN2000/00364, AU2003204958 and NZ530061. Thus, the search term suggestion mechanism may also be employed to suggest search term filters for use by the adaptive search engine as initial filters and/or as alternatives to replace filters generating irrelevant or unselected results. The search term suggestion mechanism identifies a link between different search terms that resulted in the same destination being selected by a user. The inferred connection between search terms is used to generate a database of related search terms enabling alternative search term suggestions to be provided to the user.

The present invention may use this related search term technology to identify other users who have previously clicked on destinations or search terms similar to the seeded suggestion. In one embodiment, the seeded suggestion is displayed as a search term suggestion, preferably in response to a user search term input for a related search term to the seeded suggestion. In an alternative embodiment, the seeded suggestion may also be displayed (in any type of suggestions listing) to users who also used the same (or related) search terms as users who accessed the seeded suggestion.

If a user chooses a seeded suggestion from a listing of related search terms generated by the users' initial search term, a further relationship can be identified between the seeded suggestion and the initial search term. The seeded suggestion may then be displayed to other users who have also inputted the original search term and/or any of the related search terms.

It will be appreciated that all the above techniques to enhance the targeting of the seeded suggestions are not necessarily exclusive, but may be combined in any desired manner.

Seeded Suggestion Propagation

A further important characteristic of the present invention is factors affecting the propagation of the seeded suggestion after being listed in a suggestions listing. As one of the prime driving forces behind the majority of seeded suggestions will be commercial considerations, it is important the promoter obtains a cost-effective return on any investment. This must be balanced by the search engine proprietor, by the need to maintain the user-perceived effectiveness of the search results and the relevancy of the suggestions listings; and also to ensure an effective distribution of access to users' attention by the different promoters wishing to market their separate seeded suggestions. This balance is controlled by a propagation factor that includes any convenient method to regulate the exposure of the seeded suggestions to the users.

One direct means of achieving this aim is by extending the visual lifespan of the seeded suggestion. By prolonging the time the seeded suggestion remains visible to users, the greater opportunity for the link to be accessed.

U.S. Pat. No. 6,421,675 also discloses a history factor which is a variable number between 0 and 1 used in conjunction with suggestions listings so that a suggestion's perceived popularity does not last indefinitely. In one embodiment, the suggestion value X is updated over a predetermined period according to the relationship:
X_{(new)}=(X_{(old)}.HF)+α.

Where X_{(new)} is the new calculated suggestion value, X_{(old)} is the previously calculated suggestion value, HF is the history factor and α is the number of user accesses of the suggestion over the predetermined period. Thus, the history factor HF preferentially biases the most recent user accessing of the suggestion over the previous activities.

Utilizing the above techniques the present invention may preferentially favor the seeded suggestions simply by changing the history factor to give a longer presence in the various suggestions listings. Thus, according to one embodiment, said propagation factor includes a seeded suggestion history factor SSHF with a value greater than the history factor associated with the other displayed suggestions.

In an alternative embodiment, the effective value a of each user access or ‘click’ on a seeded suggestion may be valued as proportionally more valuable than a standard suggestion, e.g. each single click made equivalent to 10 clicks. This would significantly increase the likelihood that the seeded suggestion would propagate to the suggestions of other users, particularly (if available/applicable) to other relevant search group members or direct user contacts.

Thus, according to a further embodiment, said propagation factor includes a seeded suggestion user access value SS α with a value greater than the user access value a associated with the other displayed suggestions.

As previously discussed, the majority of seeded suggestions will originate from commercial entities wishing to promote a new product or service. The present invention offers a new potential revenue stream for a search engine proprietor and a more effective means of marketing for a promoter than standard ‘pay per click’ advertising. Although not widely appreciated by most users, when a search is performed in a typical search engine some of the resulting destinations are paid or ‘sponsored’ listings, where the search engine derives a small fee ‘per click’ from the advertiser when a user clicks on their sponsored link.

The present invention provides a flexible alternative revenue model for promoters/advertisers to the standard ‘pay per click’ advertising. Fees for seeded suggestions may be calculated by different plans according to the needs of the promoter, search engine proprietor and/or the characteristics of the seeded suggestion.

Preferably, a promoter is charged a fee for displaying a seeded suggestion according to at least one of the following methods:
a fixed cost fee for doing any seeded suggestion campaign.
a fixed-cost fee per seeded suggestion displayed;
a fee for each user-access (i.e. a ‘click through’) of a seeded suggestion;
a fee per user viewing the seeded suggestion;
a fee proportional to the total traffic of the search engine, irrespective whether derived from the seeded suggestions;
a predetermined fee for displaying a seeded suggestion to targeted users selected according to users' search group membership, search history, entity attributes, identifying characteristics, connection factors, interrelationship context information, filters, data sources or the like,
a percentage of the sales that results from all of the traffic.
a combination of any or all of the above.

The fees for any of the above may be set by the search engine proprietor, or negotiated with the promoter according to the volume of promoted seeded suggestions.

In an alternative embodiment, the above fees may be determined by a user bidding system. As an example, two or more companies may want to promote for the same type of product. Thus, the competing companies bid to establish the price for the seeded suggestion and which company it will be linked to. The total return for each seeded suggestion or class of seeded suggestion may be calculated according to the total revenue it accrues. Some seeded suggestions may have a high fee per user click but a low click through rate, while others may be very popular but return a lower fee per click.

In addition to bidding by different companies for the same seeded suggestions terms, bidding may also determine which terms are included in the seeded suggestions. Furthermore, bidding could be extended to determine which destinations are included in the search results associated with a particular search term seeded suggestions.

As the promoter may gain a more targeted marketing campaign for a new product by utilizing the above described features of the present invention, a higher price per seeded suggestion than conventional pay per click advertising may still provide more cost effective returns. Moreover, the search engine proprietor is effectively able to re-sell the same space on their search engine web page, as different users' can be configured to receive different seeded suggestions instead of a single promoter's suggestion (with a single fee) being displayed to all uses.

It will be appreciated that while the features associated with the inventor's earlier-referenced applications provide an enhanced ability to target the seeded suggestions to specific users, in its most elemental form the present invention may be implemented with existing search engines without any additional functionality of customization.

In such a form, the present invention provides an adaptation to a search engine capable of providing a listing of destinations in response to searches for a user-inputted search term, said search engine further providing at least one suggestions listings derived from users search terms and/or destinations, said adaptation characterized in that at least one seeded suggestion is incorporated in at least one suggestion listing.

In a further embodiment, the present invention may be included as an added feature to an internet instant messenger service. Instant messenger clients are widely utilized internet services enabling real-time text (and optionally audio/visual) communications between users. Each user has a selectable list of contacts with whom they communicate and are alerted when any of them go online. Essentially, the instant messenger services form a social network of contacts. The addition of a search capability to the instant messenger client enables suggestions to be displayed to the user based on the search behavior of these users and their social networking information. Fee-paying promoters may thus introduce seeded suggestions into the suggestions. The seeded suggestions of interest will propagate to others in the social network, thus reflecting how information flows in real social networks.

### BRIEF DESCRIPTION OF DRAWINGS

Further aspects of the present invention will become apparent from the following description which is given by way of example only and with reference to the accompanying drawings in which:

FIG. 1 Shows a schematic representation of a first preferred embodiment of the present invention;

FIG. 2 shows a web page screen showing a search performed without any selectable filtering according to a preferred embodiment of the present invention;

FIG. 3 shows the web page shown in FIG. 2 with filtering applied from a personal contact network,

FIG. 4 shows the web page shown in FIG. 2 with filtering applied from a Mechanical Engineering search group;

FIG. 5 shows a search engine web page with filtering applied by the fishing search group, prior to the entry of any search terms,

FIG. 6a-b show a search engine web page with filtering applied by the home brewing search group in which the suggestions are represented as a ‘tag cloud’; and

FIG. 7 shows a schematic block flow chart of steps executed by a computer system programmed to implement the present invention in a preferred embodiment.

### BEST MODES FOR CARRYING OUT THE INVENTION

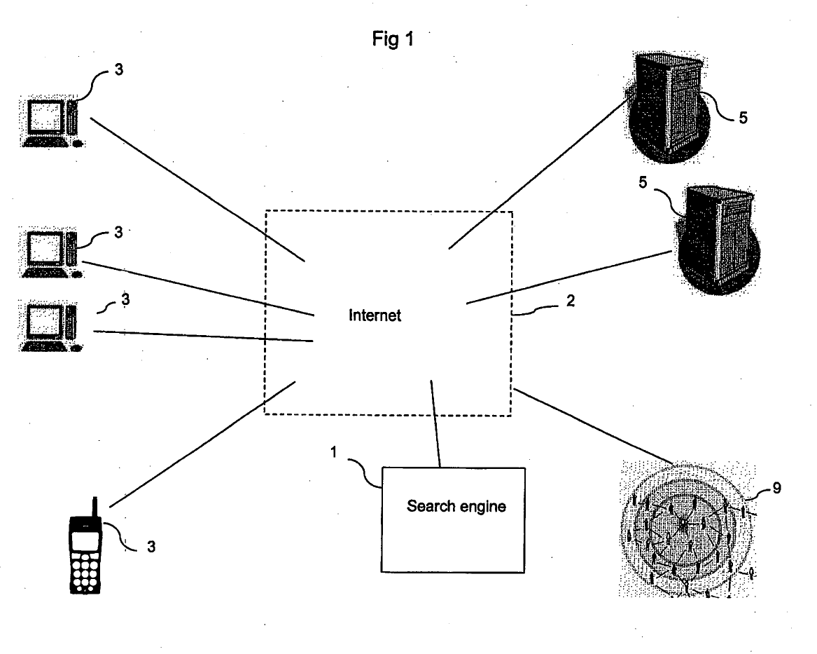

FIGS. 1-5 show preferred aspects of a first embodiment of the present invention of a search engine (1). Although the present invention may be implemented in any suitable environment with a searchable database on a network, the preferred embodiment (as shown in FIG. 1) is described with respect to use on the internet (2) in which a plurality of users (not shown) may access the search engine (1) through the internet (2) via a plurality of user sites (3) such as personal computers, laptops, mobile phones, PDAs or the like.

Although known search engines enable searching of the internet (2) for many different forms of data (including web sites, web pages, video, audio, files, graphics, databases, encryption, and the like), for the sake of clarity the preferred embodiment is described with respect to searches for destinations in the form of web sites or website links/URLs. It will be appreciated that FIG. 1 is symbolic only and that the internet (2) is actually composed of a multitude of user sites (3) and that searchable data may be obtained from a plurality of data sources (5). Moreover, although the search engine (1) is depicted as a single device, it may be distributed across a network environment including one or more data storage means (not shown), databases, server computers, processors and, although these are not explicitly shown, they are generically represented and encompassed by representation of the search engine (1).

In operation, the search engine (1) is capable of accessing and/or storing a plurality of destinations (e.g. internet web page URLs (4)) from one or more data sources (5). The destinations (4) may be stored in at least one database (not shown) and are searchable by a user-inputted search term (6) of a least one keyword (7) to produce a corresponding ranked search result listing (8) of destinations (4) outputted to the user site (3). The search engine (1) shown is thus able to operate in the typical manner of most known search engines. Optionally, the search engine (1) may also utilize features derived from the inventor's earlier applications, in particular the use of a personal contacts network (9) (shown only in FIG. 1) as disclosed in Patent Application Nos. NZ 514368, NZ 518624 and PCT/NZ02/00199 and the use of adaptive filtering as disclosed in PCT/NZ2005/000192 respectively. Both these capabilities are optional enhancements to the present invention and are not essential. However, given their advantages when used in combination with the present invention, the following description relates to embodiments of the search engine (1) incorporating these features.

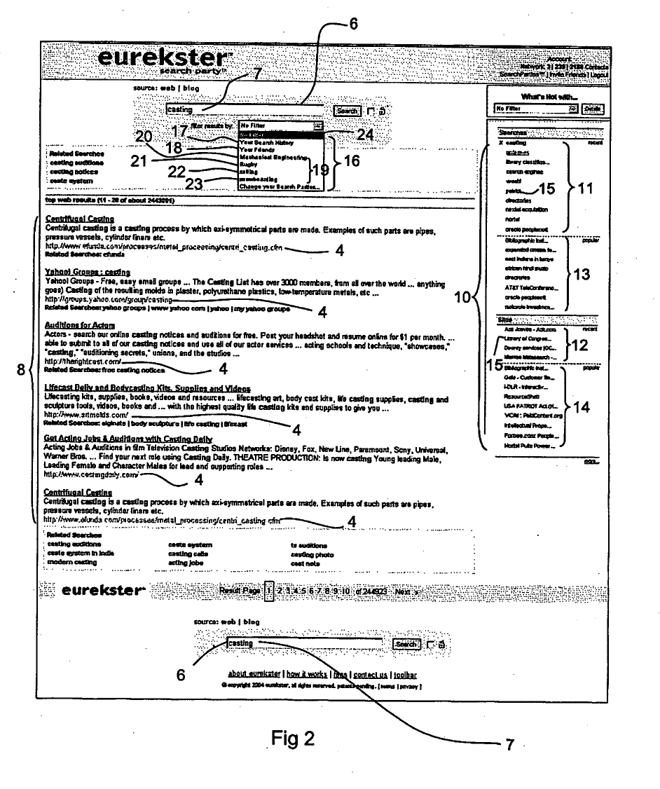

The search engine (1) also includes a plurality of suggestions (10) derived from the web activities of some, or all, of the search engine users. The suggestions (10) may incorporate both destinations (4) and/or search terms (6) and provide users with an insight to topical issues and websites of interest to other users. Although users typically access a search engine (1) with a specific search task, often users may be tempted to access a suggestion (10) out of simple curiosity. Numerous different types of suggestions (10) listings may be displayed to a user though typical suggestions (10) incorporated on known search engines (and as shown in FIG. 2) include:
recent searches (11) denoting the most recent search terms selected by users over a defined period;
recent destinations (12) denoting the most recent destinations (e.g. websites) selected by users over a defined period;
popular searches (13) denoting a ranking of the most popular search terms selected by users over a defined period,
popular destinations (14) denoting a ranking of destinations most regularly visited by users over a defined period.

Other common suggestions listings (10) (not shown) include:
high-flying searches denoting a list of search terms ranked according to their rate of change in the popular searches ranking.
high-flying destinations denoting a list of destinations ranked according to their rate of change in the popular destinations ranking.
Recent, popular, high-flying searches or destinations for paid or sponsored web listings.

In its most basic form, the search engine displays suggestions (10) based on the activities of all the search engine (1) users. The present invention provides a means for incorporating at least one seeded suggestion (15) in at least one suggestion (10) listing. A seeded suggestion (15) is not a calculated suggestion (10) obtained directly or entirely by one of the above methods or any other measurement of user-activity. Rather, a promoter (not shown) may utilize the search engine (1) to actively insert or ‘seed’ the conventional suggestions (10) listings with their seeded suggestion. The term promoter includes any commercial or non-commercial entity, organization, network or individual user who wishes to promote, market or simply generate interest in a particular destination (4) and/or search term (5). The seeded suggestions (15) may occupy a defined proportion of the time and/or the number of suggestions (10) displayed to the user. The seeded suggestions (15) may be displayed in the same manner as the other suggestions (10) or demarcated in some way, by an asterix or even by appropriate labeling. The present invention thus allows a particular website, keyword or search term or the like to be marketed actively instead of passively waiting for users to input a search term relevant to their product or service. Of even greater benefit to a potential promoter is the ability to target the seeded suggestions (15) to a more receptive group of users. This may be achieved by displaying the seeded suggestions (15) to users whose interests or background correlates to the nature of the seeded suggestion (15) by meeting predetermined user parameters. Preferably, the user parameters include, but are not restricted to, previous search history, entity attributes, identifying characteristics, connection factors, indicative information, interrelationship context information or any other convenient factor by which the type of users may be distinguished and or any combination or permutation of same. Any of these user parameters may be used to filter the search results (8) and the suggestions (10) displayed to a user. In the embodiment shown in the attached drawings, the search results (8) and suggestions (10) (and consequently, also the seeded suggestions (15)) may be selectively filtered by any of the options shown in the drop-down options menu (16) including the user's:
previous search history (17)
User contacts (labeled ‘Your friends’) (18)
membership of Search groups (19), e.g. ‘Mechanical Engineering’ (20), ‘Rugby’ (21), ‘Sailing’ (22) and ‘Snowboarding’ (23).

Seeded suggestions (15) may still be displayed to users in the suggestions (10) listings generated without any filter applied (24) from having no filter applied (24) or filtering by the user's previous search history (17). However, greater benefits are obtained for a promoter by displaying their seeded suggestions (15) in the suggestions (10) filtered by either the user's friends (user contacts) (18) and/or search groups (19).

A user's user contacts are other entities or individuals known directly or indirectly to the user. The user contacts may form part of a distinct personal contacts network (9) associated with the user and interfaced with, or forming part of, the search engine (1). The personal contacts network (9) enables the user to characterize the relationship between themselves and their user contacts and to filter/manage interaction with the user contacts according to the interrelationship context information defining the relationship. Preferably, the interrelationship context information includes a connection factor and one or more entity attributes. The connection factor provides a measure of the degree of separation between the user and the user contact, i.e. user contacts known directly to the user may be termed “direct contacts' whilst user contacts known to the user via one or more intermediary user contacts are known as “indirect contacts’.

The personal contacts network (9) is able to display indicative information to a user from searches performed by one or more entities connected directly or indirectly with the user. The indicative information is provided in the form of suggestions (10) and (optionally) destinations (4) weighting. Thus, by choosing the ‘your friends’ (18) as a filtering option, the suggestions (10) displayed to the user are derived from the most popular and recent destinations and search terms (11, 12, 13, 14) calculated from the activities of the user's user contacts and not from the activities of all the search engine (1) users. Consequently, seeded suggestions (15) placed in the various suggestions listings (11, 12, 13, 14) are more likely to propagate through the user's network of user contacts given the premise that close contacts/friends are more likely to have similar tastes.

Thus, a promoter may optimize the propagation of their seeded suggestions (15) by displaying it to users' user contacts having entity attributes, identifying characteristics, connection factors, indicative information and /or interrelationship context information relevant to the seeded suggestion (15)

The particular user contacts providing data for the suggestions (10) may be filtered or weighted according to the individual connection factor with the user. The system also records at least one entity attribute (not shown) for each of the user contacts as part of the interrelationship context information, and this may include a variety of personal details, information regarding personal details, factors or interests; friends; relations; school alumni; employment factors; business colleagues; professional acquaintances; sexual preferences, persuasions, or proclivities; sporting interests; entertainment, artistic, creative or leisure interests; travel interests, commercial, religious, political, theological or ideological belief or opinions; academic, scientific, or engineering disciplines; humanitarian, social, security/military or economic fields and any combination of same.

The search groups (16) are one form of selectable filter that provide a yet further means of targeting specific types of users with seeded suggestions (15).

In addition to search groups (16) the selectable filters also include data sources; keyword filters; user submissions—including user comments, answers to questions, chat-room threads, blog inputs and the like, news, pictures; human editorial control/moderator; user-behavior analysis; Keyword suggestions; Website filters; Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or mature content filters.

A data source (5) may be any form of searchable source of data, including web sites (4), personal contact networks (9), domain names and categories, news groups, search groups (20), third part search engines including category-specific search engines, geographical regions, blog sites, intranets, LAN and WAN networks and the like.

The filters maybe used to provide a weighting to the search results (8) according to the techniques described in PCT/NZ2005/000192. However, for explanatory purposes of the present invention, the following description is restricted to the use selectable filters, in particular search groups (16), on the associated suggestions (10) displayed to the user.

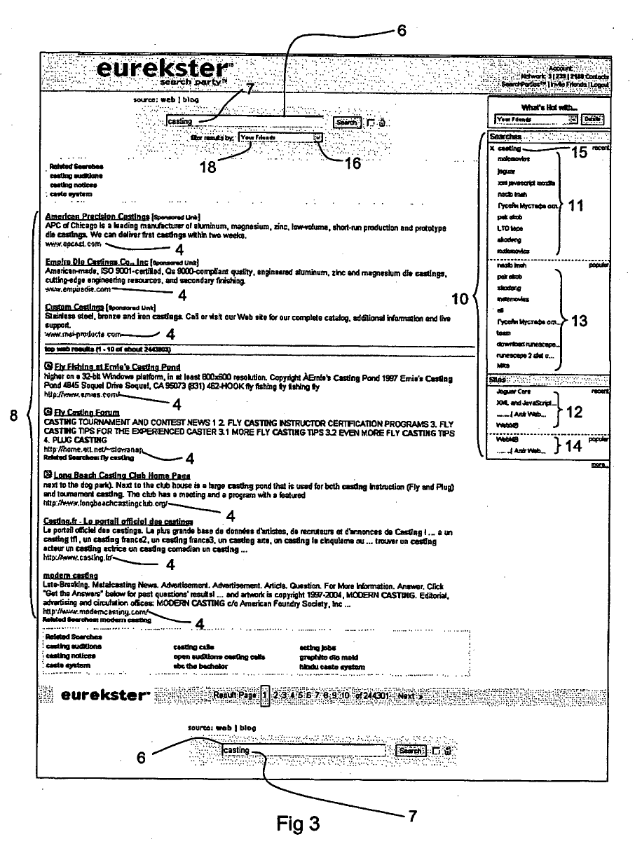

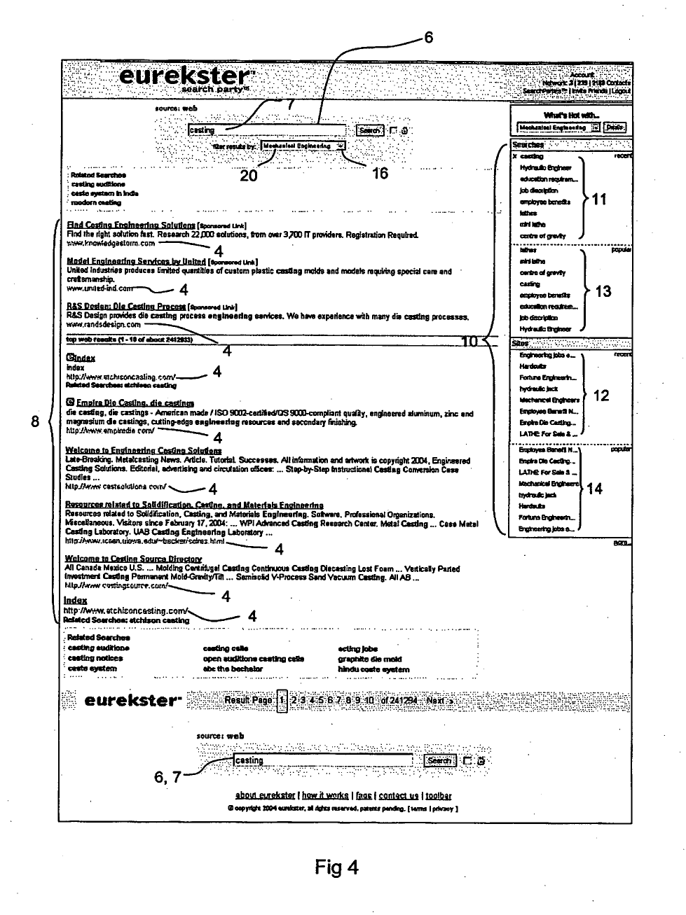

A search group (16) in its basic form is a category-specific group of users with similar views of what is relevant. Consequently, search group (16) members may share numerous types of information including their search results listings (8), preferred data sources, and re-ranking data to weight the search results (8). The user selections from resulting search listings (8) will be re-ranked according to the relevancy of the result according to the techniques previously discussed. The filtering effect of a search group (16) is also applied to the destinations (4) and search terms (6) used by the search group (16) members to populate the corresponding suggestions (10) listings generated. The ability of search groups (16) to enhance the relevance of the search results (8) and suggestions (10) is illustrated in FIGS. 2-4 which show the different effects of a search term (6) with the keyword (7) ‘casting’ performed with no filtering in FIG. 2, filtering from the user contacts (18) of a personal contacts network (9) in FIG. 3 and filtering by the ‘Mechanical engineering’ search group (20) in FIG. 4.

In isolation, the user's intention behind the terms ‘casting’ as search term (6) is ambiguous; the user's interest may be related to acting, fishing, sculpture or engineering. Thus, a promoter wishing to market the casting products or services of an engineering company who pays to display a seeded suggestion (15) for the search term ‘casting’ firm may receive spurious initial enquires from users interested in non-engineering casting. If the promoter pays the search engine (1) proprietor on a ‘pay per click’ rate, the cost-effectiveness of displaying to such a general audience is affected. It can be seen in FIG. 2 that over half of the search results (8) and all of the suggestions (10) are unrelated to engineering castings.

FIG. 3 shows the same search for “casting” filtered by the user's ‘friends’, i.e. user contacts (18). The ‘friends’ (18) may be individuals specifically invited by the user to pool search results. This is in effect a search group (19) in all but name whose common link is the friendship/acquaintanceship between the members. Alternatively, the ‘friends’ (18) may be derived from the user's user contacts in a personal contact network (9). Filtering by the user's friend (18) may generate search results (8) with more relevance to the user, if the user's user contacts (18) have similar tastes and interests. If the user is interested in acting, there is an increased likelihood their direct user contacts (18) may have similar interests, thus biasing the associated search results (8) and suggestions (10) accordingly. The promoter seeking to market the casting products/services of an engineering company may still not wish to place their seeded suggestions (15) in the associated suggestions (10) listings without some indication the user contacts may be interested in engineering castings. However, a user knowing that the user contacts of their personal contacts network (9) are interested in engineering matters may wish to display the ‘casting’ seeded suggestion (15) in the associated suggestions (10) listing.

FIG. 4 shows the search engine (1) web page for the same search term (6) ‘casting’, conducted with the Mechanical Engineering search group filter (20). It can be seen all of the search results are germane and equally, all of the suggestions (10) are engineering related. Thus, inserting a seeded suggestion (15) for casting into the suggestions (10) for any search performed with the mechanical engineering search group (20) is far more likely to be seen by a receptive audience.

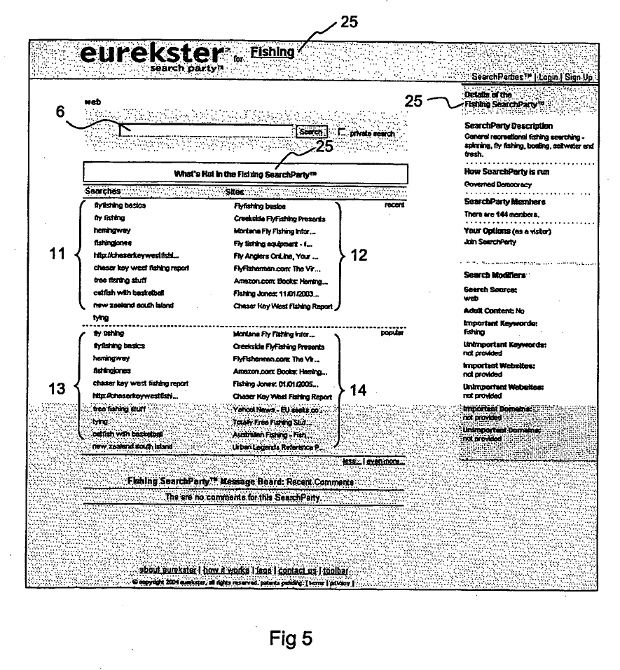

FIG. 5 shows an alternative web page layout to that shown in the above embodiments, where the user has selected the ‘fishing’ search group (25) to filter their results, but has not yet inputted a search term (6). The suggestions (11, 12, 13, 14) are displayed more prominently in the centre of the web page in the absence of any search results (8).

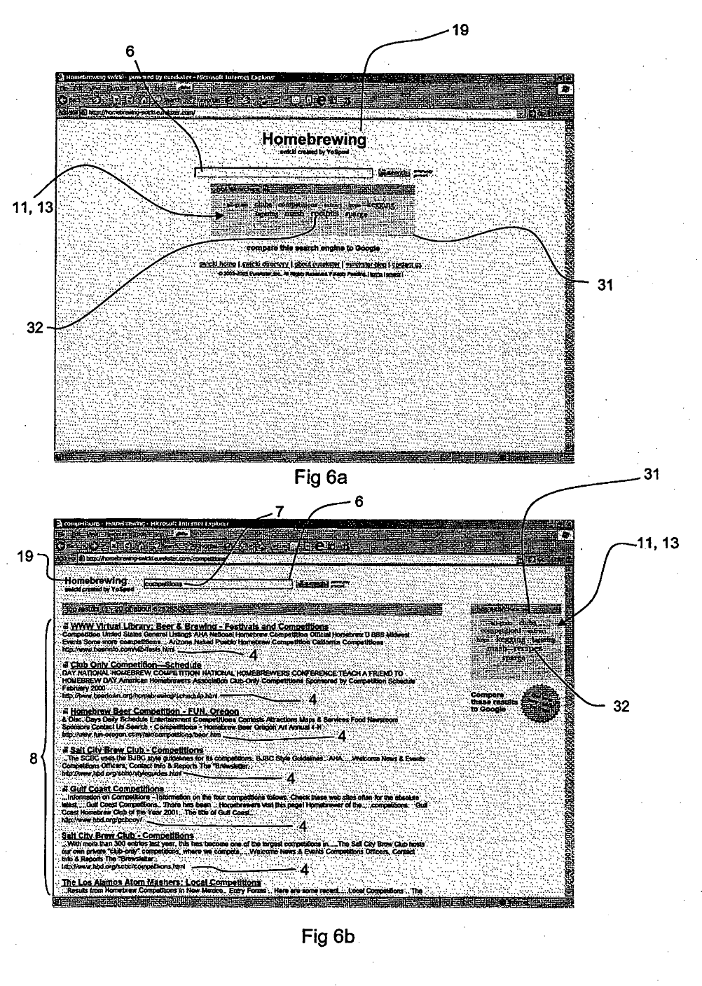

FIG. 6a) and b) show a further alternative web page layout embodiment in which the suggestions (10) are represented as a ‘tag cloud’ (31) rather than as a linear list as shown in the preceding embodiments. The tag cloud (31) is a cluster or grouping of suggestions which may be derived from any of the previous discussed sources, e.g. recent searches (11), popular searches (13) and the like. The tag cloud (31) format for displaying the suggestions (10) provides several advantages over a conventional vertical listing. Firstly, the tag cloud (31) provides a more intriguing and eye catching visual appearance increasing the likelihood of a user's interest or curiosity being stimulated enough to click on a suggestion (10). Secondly, the non-linear cluster configuration avoids any directly implied hierarchy of a linear listing and enables alternative means of emphasizing individual suggestions (10) to be employed. The prominence of one or more suggestions (10) may be adjusted by variation in the size, colour, contract, shape, pattern, location within the cluster (31) and even an audio output associated with each suggestion (10). The most prominent suggestion (32) at any given instant may or may not be a seeded suggestion (15), depending on the configuration of the search engine.

The prominence of the individual suggestions (10) may vary with time, their popularity and, in the case of a seeded suggestion (15), vary according to the fee paid by an associated promoter.

It will be appreciated the suggestions (10) and seeded suggestions (15) need not necessarily be text but may also be graphical representations or audio and/or visual clips.

FIG. 6a) shows a web search page for a category-specific search group (19) for ‘Homebrewing’ prior to a search term (6) being inputted, while FIG. 6b) shows the same web page after a search has been performed for the search term (6) ‘competitions’. It will be noted that the search term ‘competitions’ was also a suggestion/seeded suggestion (10, 15) in the tag cloud (31) having been previously identified as being an important term by the search group (19) moderator, or being derived from the compilation of popular searches or recent searches (11, 13) and/or a seeded suggestion (15). It will be seen that despite the generic nature of a search term ‘competitions’, the results listings (8) generated are all pertinent to home brewing competitions.

In an alternative embodiment search groups (19) may be constituted by all the users of a search engine link on a category-specific or specialized web-site. Such a configuration would require no active ‘joining’ of a search group which is perceived as an unduly inconvenient task for the overwhelming majority of web users. In contrast, it can be inferred form the user's presence on the specialized web-site that the user has an interest in the subject matter of the website, e.g. a user accessing a fishing website has an interest in fishing. Moreover, if a user performs a search from a search link on such a specialized site, it is a reasonable supposition that any searches performed from that site would be at least generally related to the subject matter of the web-site.

Thus, the relevant subject matter of the web-site hosting the search link provides an ideal source of one of more filters to be automatically applied by the search engine to searches undertaken through that site. The same approach may also be used to apply targeted seeded suggestions (15) to users of the web-site.

The propagation of the seeded suggestion (15) after being listed in a suggestions (10) listing may be varied according to several different techniques. The majority of seeded suggestions (15) will be inputted by promoters in the form of commercial entities for a fee charged by the search engine (1) proprietor. Thus, it is desirable for both parties to be able to maximize the exposure of the seeded suggestion (15) to the most relevant users. The degree of exposure of each seeded suggestion (15) is controlled in part by a propagation factor that includes any convenient method to regulate the exposure of the seeded suggestions to the users. Ultimately, the propagation of the seeded suggestion (15) depends on the reaction of the users; whether they are interested enough to follow the link and whether their user contacts and/or search group members also access the seeded suggestion (15) as it propagates to their respective suggestions (10) listings. The visual lifespan of the seeded suggestion (15) may be extended, by artificially prolonging the time the seeded suggestion (15) remains visible to users, thereby giving greater opportunity for the link to be accessed.

One type of propagation factor is the history factor which is a variable number between 0 and 1 used in conjunction with suggestions (10) listings to ensure previously popular suggestions (10) do not dominate indefinitely. Thus, destinations (4) specific to a particular soccer world cup may receive a huge number of hits during the period of the tournament, but users will not typically be interested in theses sites after the tournament end. The use of a history factor prevents the old popularity masking a drop in more recent hits from users. Expressed mathematically, the history factor HF is given by the expression X_{(new)}=(X_{(old)}.HF)+α, where X_{(new)} is the new calculated suggestion (10) value measured over a predetermined period, X_{(old)} is the previously calculated suggestion value, HF is the history factor and α is the number of user accesses of the suggestion over the predetermined period. Thus, the history factor HF preferentially biases the most recent user accessing of the suggestion (10) over the previous activities. The seeded suggestions (15) may thus be preferentially favored over the other suggestions (10) displayed to the user by virtue of a higher value history factor to give a longer presence in the various suggestions (10) listings.

An alternative propagation factor involves the use of α, the number of user-accesses of a suggestion (10) over the predetermined period. Instead of each click on an individual's seeded suggestions (15) link being counted once as per the conventional suggestions, it may be accorded a multiplied value, e.g. each single click made equivalent to ten clicks. The multiplied value may be a fixed constant for all seeded suggestions (15) or be varied according to the fee charged, or the type of customer/promoter, or nature of seeded suggestion (15) and the targeted market. As an example, a seeded suggestion (15) placed in the suggestions (10) listings of a very popular search group (19), may attract a higher fee than more obscure, low membership search groups (19).

Several revenue schemes may be implemented for promoters to pay for seeded suggestions (15) including:
a fixed cost fee for promoting any seeded suggestion (15) campaign;
a fixed-cost fee per seeded suggestion (15) displayed;
a fee for each user-access (i.e. a ‘click through’) of a seeded suggestion (15);
a fee per user viewing the seeded suggestion (15);
a fee proportional to the total traffic of the search engine (1), irrespective whether derived from the seeded suggestions (15).
a predetermined fee for displaying a seeded suggestion (15) to targeted users selected according to users' search group membership, search history, entity attributes, identifying characteristics, connection factors, interrelationship context information, filters, data sources or the like,
a percentage of all of the sales that result from each click through,
a combination of any or all of the above.

In a further embodiment (not illustrated), the fees for any of the above may be calculated by the search engine proprietor, or negotiated with the promoter according to the volume of promoted seeded suggestions.

In further embodiments, the above fees may be determined by a user-bidding system. Two or more promoters may bid for:
The same seeded suggestions (15) term;
The destinations (4) associated with a seeded suggestion (15) search term (6), and
Which seeded suggestions (15) are displayed in the suggestions listings.

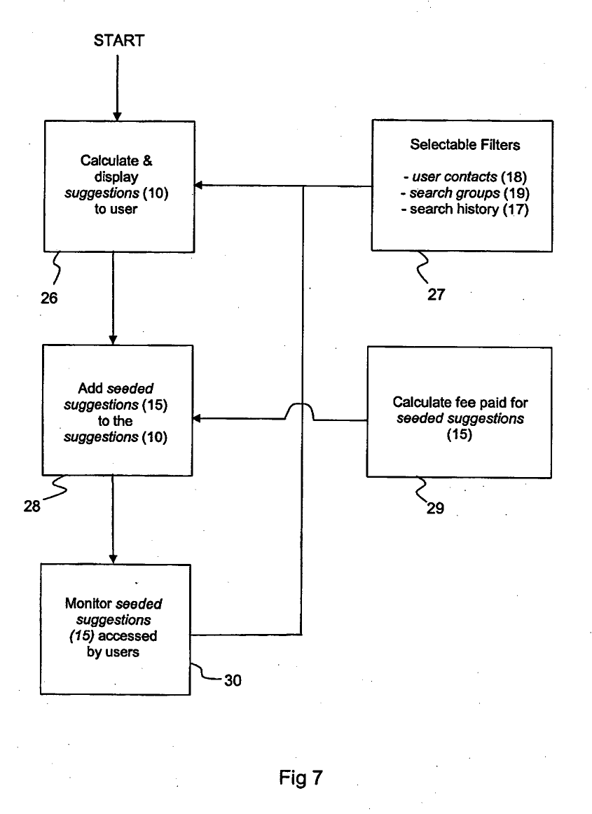

FIG. 7 shows a block schematic flow chart of the steps executed by the search engine (1) to implement a method of targeted marketing provided by the present invention. Considering as an illustrative example a search engine (1) with the features displayed on the web page shown in FIGS. 2-5, in the initial method step (26), the search engine (1) populates the suggestions (10). The various types of suggestions (11, 12, 13, 14) displayed are populated by recent searches (11) or destinations (12), or popular searches (13) or destinations (14) calculated according to the relevant criteria for the individual suggestions listing. In an optional second step (27), the use may choose to filter their search by a user selectable filter, e.g. any of the options shown in the drop-down options menu (16) shown in FIG. 2 including the user's previous search history (17), User contacts (labeled ‘Your friends’) (18), membership of Search groups (19), such as ‘Mechanical Engineering’ (20), ‘Rugby’ (21), Sailing (22) and ‘Snowboarding’ (23).

The search engine (1) then adds seeded suggestions (15) in the next method step (28) to the individual suggestions (10). The seeded suggestions (15) may be chosen according to the type of filter applied by the user and/or any other commercial arrangement between the proprietor of the search engine (1) and the promoter of the seeded suggestions (15). A promoter may, for example wish their particular seeded suggestion (15) to be displayed whenever a user filters their results by selecting a certain search group (19). The fee charged for the promoter is calculated in step (29) from a number of alternative schemes (as described above) such as a fixed-cost fee per seeded suggestion (15) displayed, a fee per user viewing the seeded suggestion (15), or the like.

Subsequently, in step (30) the search engine monitors which suggestions (10) are accessed by the user and the method is repeated again at the initial step (26). If the user selects a seeded suggestion (15) from the recent sites (14) listing for example, this may, according to the configuration of the search engine, also appear (or be more likely to appear) on corresponding suggestions (10) displayed to other members of the search group (19) or the those displayed to the user's friends/user contacts (18).

The present invention may also be used with simplified search engines which do not have the additional functionality provided by the applicant's previous inventions. The seeded suggestions (15) are simply placed in the suggestions (10) displayed to all users. The present invention may equally be implemented as a part of a search toolbar added to non-search engine websites.

In a further embodiment (not shown), the present invention may be included as an added feature to an Internet instant messenger (IM) service. Each IM user has a selectable list of contacts with whom they communicate and are alerted when any of them go online, effectively forming a social network of contacts. A search capability may be added to the IM client enabling suggestions (10) to be displayed to the user based on the search behavior of the user's contacts and their social networking information. In accordance with earlier embodiments, seeded suggestions (15) may be displayed with the suggestions (10) and those of interest will propagate to others in the social network, thus reflecting how information flows in real social networks.

1. A search engine capable of providing a listing of destinations in response to searches for a user-inputted search term, said search engine further providing at least one suggestions listing derived from users previously inputted search terms and/or destinations selected, characterized in that
at least one seeded suggestion is incorporated in at least one suggestion listing.

2. A search engine as claimed in claim 1, wherein the suggestions and associated seeded suggestions are displayed to the user either integrally and/or externally to the search engine.

3. A search engine as claimed in claim 2, wherein suggestions and associated seeded suggestions displayed to the user integrally and/or externally to the search engine respectively include and omit a dynamic link to the search engine.

4. A search engine as claimed in claim 1, wherein said seeded suggestions occupy a defined proportion of, and/or position in, the suggestions displayed to a user.

5. A search engine as claimed in claim 4, wherein said defined proportion includes a proportion of the time, and/or the number of suggestions displayed to the user.

6. A search engine as claimed in claim 1, wherein said seeded suggestions are displayed to users meeting predetermined user parameters.

7. A search engine as claimed in claim 6, wherein the user parameters include, but are not restricted to, the user's search history, entity attribute, identifying characteristic, and/or connection factor.

8. A search engine as claimed in claim 1, wherein said search terms includes keywords, images, sounds, alphanumeric data, and/or any other query used as the user input for searches performed by the search engine.

9. A search engine as claimed in claim 1, wherein suggestions incorporate destinations and/or search terms.

10. A search engine as claimed in claim 1, wherein said suggestions include, but are not restricted to:
recent searches denoting the most recent search terms selected by users over a defined period;
recent destinations denoting the most recent destinations (e.g. websites) selected by users over a defined period;
popular destinations denoting a ranking of destinations most regularly visited by users over a defined period;
popular searches denoting a ranking of the most popular search terms selected by users over a defined period;
high-flying searches denoting a list of search terms ranked according to their rate of change in the popular searches ranking;
high-flying destinations denoting a list of destinations ranked according to their rate of change in the popular destinations ranking and/or
recent, popular, high-flying searches or destinations for paid or sponsored web listings.

11. A search engine as claimed in claim 2, wherein externally displayed suggestions are distributed to users via any of: email; electronic newsletters; RSS feeds, text messaging and/or any combination of same.

12. A search engine as claimed in claim 1, configured to applying weighting to the search results by increasing the ranking of a selected destination over an unselected destination in the search results listing.

13. A search engine as claimed in claim 1, wherein said search engine classifies a selection of destinations as being relevant when the user performs at least one action in association with the selected destination to meet at least one predetermined relevancy criteria.

14. A search engine as claimed in claim 13, wherein said predetermined relevancy criteria includes whether the user accesses a destination for longer than a predetermined period, accesses further destinations directly from the first selected destination and/or submits/downloads data to/from the destination.

15. A search engine as claimed in claim 1, configured to interface with a personal contacts network of user contacts formed from contacts with one or more entities known directly or indirectly to the user, wherein said personal contacts network provides respective interrelationship context information associated between at least two entities and/or between an entity and the user.

16. A search engine as claimed in claim 15, wherein said interrelationship context information includes one or more entity attributes and/or a connection factor indicative of the degree of separation between the user contact and the user.

17. A search engine as claimed in claim 1, capable of displaying indicative information in the form of suggestions and/or destinations weighting to a user from searches performed by one or more entities connected directly or indirectly with the user.

18. A search engine as claimed in claim 15, wherein the suggestions displayed to a user from the user contacts is user-variable according to a selective input from the user contacts.

19. A search engine as claimed in claim 18, wherein the selective input mayfilter the suggestions according to at least one filter criteria including the elapsed period since the suggestion creation, the interrelationship context information, the connection factor and/or entity attributes of the contributing user contacts.

20. A search engine as claimed in claim 1, wherein the suggestions and seeded suggestions are displayed in a non-linear on-screen cluster arrangement.

21. A search engine as claimed in claim 20, configured such that the relative prominence of the individual suggestions and/or seeded suggestions with respect to each other within said cluster is adjustable by variations in the suggestions and seeded suggestions size, colour, contrast, pattern, shape, and/or audio output.

22. A search engine as claimed in claim 21, wherein said seeded suggestion prominence is at least partially governed by the magnitude of a display fee paid by a promoter, the display duration, and/or previous popularity in preceding searches.

23. A search engine as claimed in claim 19, configured to allow a user to apply a selective input to the user's suggestions by using a filter criteria of controlling the value of N^{th} degree of contact of entities to be included, where N is a variable determined by the user.

24. A search engine as claimed in claim 23, wherein the filter criteria for said selective input may be linked to a predetermined activity.

25. A search engine as claimed in claim 24, wherein a user engaged in one or more said predetermined activities may specify the action to apply to
all degrees of contact in the user's personal contacts network, at any connection path length, or
all system users, including those who are not connected to the user.

26. A search engine as claimed in claim 23, configured to receive selective input from networks outside the system network.

27. A search engine as claimed in claim 15, wherein the user contacts associated with the suggestions most frequently selected by the user are designated preferred user contacts.

28. A search engine as claimed in claim 27 wherein the selective input may be at least partially weighted to suggestions from the preferred user contacts.

29. A search engine as claimed in claim 1, wherein the search engine records an association between a filter applied to a search term and an individual destination selected by a user from a filtered portion of the destinations listing, wherein each recorded association contributes to the weighting given by the search engine to application of said filter in a subsequent search for at least one keyword of said search term.

30. A search engine as claimed in claim 29, wherein said filters include, but are not limited to: one or more said data sources; Keyword filters; user submissions—including user comments, answers to questions, chat-room threads, blog inputs and the like, news, pictures; search groups; human editorial control/moderator; user-behavior analysis; Keyword suggestions; Website filter; Domain filters; Link analysis filters; Category filters; Class of query (ranked according to whether or not the search query had been performed previously and if so, on search success); Advanced rule-based learning adaptations of other filters; Data item creation or update date; User's geographic location; Language; File format, frequency of spidering web-pages; and/or Mature Content filter.

31. A search engine as claimed in claim 30, wherein data sources includes; search groups, web sites, domain names and categories, personal contact networks, news groups, third party search engines including category-specific search engines, geographical regions, blog sites, intranets, LAN and WAN networks, and/or any other form of searchable source of data.

32. A search engine as claimed in claim 30, wherein search groups are a category-specific group of users sharing search results and/or preferred data sources; each search group user having at least one common entity attribute.

33. A search engine as claimed in claim 32, wherein a search group is formed from any users using a search engine link on a category-specific or specialized web-site.

34. A search engine as claimed in claim 29, wherein the initial or default choice of filters may be made manually by the user, or by a search group or search engine moderator and/or inferred from settings specified external to the search engine. search engine moderator and/or inferred from settings specified external to the search engine.

35. A search engine as claimed in claim 29, wherein the initial filters applied by the search engine are selected according to one or more context indicators.

36. A search engine as claimed in claim 35, wherein initial selection of said filter is either user-selected or calculated from one or more predetermined relationships incorporating at least one context indicator related to characteristics of the user, the filter or both.

37. A search engine as claimed in claim 35, wherein context indicators include any definable and recordable facet or characteristic of a filter selected by a user and/or a user's interests, contact details, personal or bibliographic details, previous search behavior, web surfing behavior, cookie information, occupation, membership or use of search groups, information shared as part of trusted personal contacts networks, geographical location, language, domain name type, data voluntarily inputted by the user into the search engine.

38. A search engine as claimed in claim 29, including a search term suggestion mechanism capable of providing search term filters for use by the adaptive search engine as initial filters and/or as alternatives to replace filters generating irrelevant or unselected results.

39. A search engine as claimed in claim 38, wherein the search term suggestion mechanism identifies a link between different search terms that resulted in the same destination being selected by a user and uses the inferred connection between search terms to generate a database of related search terms for providing the user with alternative search term suggestions.

40. A search engine as claimed in claim 38, wherein the seeded suggestion is displayed as a search term suggestion.

41. A search engine as claimed in claim 40, wherein the seeded suggestion is displayed as a search term suggestion in response to a user search term input for a related search term to the seeded suggestion.

42. A search engine as claimed in claim 41, wherein the seeded suggestion is also be displayed to users who also used the same or related search terms as users who accessed the seeded suggestion.
a seeded suggestion history factor (SSHF) with a value greater than the history factor associated with the other displayed suggestions and/or
a seeded suggestion user access value (SS α) with a value greater than the user access value α associated with the other displayed suggestions.

44. A search engine as claimed in claim 1, including
at least one host computer processor connectable to one or more network(s),
a database accessible over said network(s),
a plurality of data input devices connectable to said network(s).

45. A method of displaying to a user on a display screen a seeded suggestion using the search engine as claimed in claim 1.

46. A method as claimed in claim 45, wherein a promoter is charged a fee for displaying a seeded suggestion according to at least one of the following:
a fixed cost fee for doing any seeded suggestion campaign;
a fixed-cost fee per seeded suggestion displayed;
a fee for each user-access (i.e. a ‘click through’) of a seeded suggestion;
a fee per user viewing the seeded suggestion;
a fee proportional to the total traffic of the search engine, irrespective
a fee for each user-access (i.e. a ‘click through’) of a seeded suggestion;
a fee per user viewing the seeded suggestion;
a fee proportional to the total traffic of the search engine, irrespective whether derived from the seeded suggestions;
a predetermined fee for displaying a seeded suggestion to targeted users selected according to users' search group membership, search history, entity attributes, identifying characteristics, connection factors, interrelationship context information,filters, data sources or the like;
a percentage of the sales that results from all of the traffic;
a combination of any or all of the above.

47. A method as claimed in claim 45, wherein a fee charged for displaying a seeded suggestion is determined by a user bidding system.

48. A method as claimed in claim 47, wherein said bidding also determines which terms are included in the seeded suggestions.

49. A method as claimed in claim 47, wherein said bidding determines which destinations are included in the search results associated with a particular search term seeded suggestions.

50. A software adaptation to an existing search engine capable of providing a listing of destinations in response to searches for a user-inputted search term, said search engine further providing at least one suggestions listings derived from users search terms and/or destinations, said adaptation characterized in that at least one seeded suggestion is incorporated in at least one suggestion listing.
